(19) United States
(12) Patent Application Publication
(10) Pub. No.: US 2018/0253556 A1
(43) Pub. Date: Sep. 6, 2018

(54) SELECTIVE RESTORATION AND AUTHENTICATION OF A SECURE IMAGE

(71) Applicant: QUALCOMM Incorporated, San Diego, CA (US)

(72) Inventors: Chad KARAGINIDES, Ramona, CA (US); Dhaval PATEL, San Diego, CA (US); Dhamim PACKER ALI, San Diego, CA (US); Selvaraj JAIKUMAR, San Diego, CA (US); Venkateshwar JUNNUTHULLA, Austin, TX (US)

(21) Appl. No.: 15/485,561

(22) Filed: Apr. 12, 2017

Related U.S. Application Data
(60) Provisional application No. 62/466,207, filed on Mar. 2, 2017.

(51) Int. Cl. G06F 21/57; G06F 21/44; G06F 1/32

(52) U.S. Cl. CPC G06F 21/575; G06F 21/44; G06F 9/445; G06F 1/3287; G06F 1/3275; G06F 21/572

(57) ABSTRACT

Techniques for operating a computing device in one or more power modes are provided. An example method for operating a computing device according to these techniques includes determining whether a threshold condition for exiting a first power mode has been satisfied, identifying one or more segments of a volatile memory that were powered down while the computing device was operating in the first power mode responsive to the threshold condition being satisfied, identifying one or more segments of software that were stored in the one or more segments of the volatile memory that were powered down, restoring, from a non-volatile memory, the one or more segments of the software to the one or more segments of the volatile memory that were powered down, and authenticating the one or more segments of the software.

### CLAIM OF PRIORITY UNDER 35 U.S.C. § 119

The present Application claims the benefit of and priority to U.S. Provisional Application Ser. No. 62/466,207 entitled “SELECTIVE RESTORATION AND AUTHENTICATION OF A SECURE IMAGE,” filed Mar. 2, 2017, which is assigned to the assignee hereof, and expressly incorporated herein by reference.

### BACKGROUND

Secure booting of a computing device with authorized and trusted software is important to original equipment manufacturers (OEMs), network service providers that provide wireless and/or wired network connectivity to the computing device, and the end user of the device. The OEM has an interest in protecting the devices that they manufacture from running unauthorized software that could damage or degrade the performance of the device. Network service providers, such as wide-area network (WAN), cable Internet providers, WiFi network providers, have an interest in preventing unauthorized software from being run on computing devices utilizing their networks, because such unauthorized software may degrade the performance of the network, the computing device, or both. The end user has an interest in protecting their device from running unauthorized software which could damage their computing device (perhaps even beyond repair) or which may compromise the security of sensitive data on the computing device.

When the device is booted, the secure software is loaded into volatile memory of the computing device by a boot loader and authenticated before the computing device becomes fully operational. Computing devices may be configured to operate in a low power mode in which some components of the computing device are powered down to conserve power. Mobile computing devices, such as a smartphone, smartwatch, tablet, or laptop computer, may be configured to enter a low power operating mode to conserve power of a battery or other onboard power source. Other computing devices may have external power supplies, but enter into a low power mode to reduce power consumption by the computing device when the device is idle. However, when the computing device exits the low power mode, the computing device may need to completely reload and re-authenticate any secure executable content that was loaded and authenticated at the time that the device was initially booted from a cold boot to ensure that all of the required software is available in volatile memory and that the software has not been corrupted or modified.

### SUMMARY

An example method for operating a computing device according to the disclosure includes determining whether a threshold condition for exiting a first power mode has been satisfied, identifying one or more segments of a volatile memory that were powered down while the computing device was operating in the first power mode responsive to the threshold condition being satisfied, identifying one or more segments of software that were stored in the one or more segments of the volatile memory that were powered down, restoring, from a non-volatile memory, the one or more segments of the software to the one or more segments of the volatile memory that were powered down, and authenticating the one or more segments of the software.

Implementations of such a method can include one or more of the following features. Booting the computing device, using the software, in a second power mode responsive to authenticating the one or more segments of the software restored to the volatile memory, the first power mode being a lower power mode than the second power mode. Powering up the one or more segments of the volatile memory that were powered down while the computing device was operating in the first power mode responsive to the threshold condition being satisfied. Identifying the one or more segments of the volatile memory that were powered down while the computing device was operating in the first power mode includes determining the based on a power mode type associated with the first power mode. Determining the one or more segments of the volatile memory includes determining the one or more segments of the volatile memory based on a hardware configuration of the computing device. Executing a power mode recovery handler stored in one or more other memory segments that were not powered down while operating the computing device in the first power mode. Determining the first power mode under which to operate the computing device, selecting one or more memory banks to be powered down based on the first power mode, and powering down the selected memory banks. The software can include secure executable software. The secure executable software can include a secure executable software image.

An example computing device according to the disclosure includes means for determining whether a threshold condition for exiting a first power mode has been satisfied, means for identifying one or more segments of a volatile memory that were powered down while the computing device was operating in the first power mode responsive to the threshold condition being satisfied, means for identifying one or more segments of software that were stored in the one or more segments of the volatile memory that were powered down, means for restoring, from a non-volatile memory, the one or more segments of the software to the one or more segments of the volatile memory that were powered down, and means for authenticating the one or more segments of the software.

Implementations of such an apparatus can include one or more of the following features. Means for booting the computing device, using the software, into a second power mode responsive to authenticating the one or more segments of the software restored to the volatile memory, the first power mode being a lower power mode than the second power mode. Means for powering up the one or more segments of the volatile memory that were powered down during the first power mode responsive to the threshold condition being satisfied. The means for identifying one or more segments of the volatile memory that were powered down while the computing device was operating in the first power mode includes means for determining the one or more segments of the volatile memory based on a power mode type associated with the first power mode. The means for determining the one or more segments of the volatile memory includes means for determining the one or more segments of the volatile memory based on a hardware configuration of the computing device. Means for executing a power mode recovery handler stored in one or more segments of the volatile memory that were not powered down while the computing device was operating in the first power mode. Means for determining the first mode under which to operate the computing device, means for selecting one or more memory banks to be powered down based on the first power mode, and means for powering down the selected memory banks. The software can include secure executable software. The secure executable software can include a secure executable software image.

An example computing device according to according to the disclosure includes a volatile memory, a non-volatile memory, software for booting the computing device stored in the non-volatile memory, and a processor communicatively coupled to the volatile memory and the non-volatile memory. The processor is configured to determine whether a threshold condition for exiting a first power mode has been satisfied, identify one or more segments of the volatile memory of the volatile memory that were powered down during the first power mode responsive to the threshold condition being satisfied, identify one or more segments of software that were stored in the one or more segments of the volatile memory that were powered down, restore, from the non-volatile memory, the one or more segments of the software to the one or more segments of the volatile memory that were powered down, and authenticate the one or more segments of the software restored to the non-volatile memory.

Implementations of such a computing device can include one or more of the following features. The processor is further configured to boot the computing device using the software into a second power mode responsive to authenticating the one or more segments of the software copied to the volatile memory. The processor is further configured to power up the one or more segments of the volatile memory that were powered down while the computing device was operating in the first power mode responsive to the threshold condition being satisfied. The processor being configured to identify one or more segments of the volatile memory that were powered down while the computing device was operating in the first power mode is further configured to determine the one or more segments of the volatile memory based on a power mode type associated with the first power mode. The processor is configured to determine the one or more segments of the volatile memory based at least in part on a hardware configuration of the computing device. The processor is further configured to execute a power mode recovery handler stored in one or more segments of the volatile memory that were not powered down while the computing device was operating in the first power mode. The processor is further configured to determine the first mode under which to operate the computing device, select one or more memory banks to be powered down based on the first power mode, and power down the selected memory banks. The software can include secure executable software. The secure executable software can include a secure executable software image.

An example non-transitory, computer-readable medium, having stored thereon computer-readable instructions for operating a computing device, according to the disclosure includes instructions configured to cause the computing device to determine whether a threshold condition for exiting a first power mode has been satisfied, identify one or more segments of a volatile memory that were powered down while computing device was operating in the first power mode responsive to the threshold condition being satisfied, identify one or more segments of software that were stored in the one or more segments of the volatile memory that were powered down, restore, from a non-volatile memory, the one or more segments of the software to the one or more segments of the volatile memory that were powered down, and authenticate the one or more segments of the software.

Implementations of such a non-transitory, computer-readable medium can include one or more of the following features. Instructions configured to cause the computing device to boot the computing device, using the software, into a second power mode responsive to authenticating the one or more segments of the software restored to the volatile memory. Instructions configured to cause the computing device to power up the one or more segments of the volatile memory that were powered down while the computing device was operating in the first power mode responsive to determining that the threshold condition has been satisfied. The instructions configured to cause the computing device to identify one or more segments of the volatile memory that were powered down while the computing device was operating in the first power mode include instructions configured to cause the computing device to determine the one or more segments of the volatile memory based on a power mode type associated with the first power mode. The instructions configured to cause the computing device to determine the one or more segments of the volatile memory include instructions configured to cause the computing device to determine the one or more segments of the volatile memory based on a hardware configuration of the computing device. Instructions configured to cause the computing device to execute a power mode recovery handler stored in one or more segments of the volatile memory that were not powered down while the computing device was operating in the first power mode. Instructions configured to cause the computing device to determine the first power mode under which to operate the computing device, select one or more memory banks to be powered down based on the first power mode, and power down the selected memory banks. The software can include secure executable software. The secure executable software can include a secure executable software image.

### BRIEF DESCRIPTION OF THE DRAWINGS

FIG. 1 is a schematic diagram of an example computing device in which the techniques disclosed herein can be implemented, in accordance with certain example implementations.

FIGS. 2A, 2B, 2C, and 2D are schematic diagrams illustrating the contents of the secure executable image and the volatile memory of the computing device to illustrate an example implementation of the techniques disclosed herein.

FIG. 3 is a flow chart of a process for securely booting a computing device according to the techniques disclosed herein.

FIG. 4 is a flow diagram of a process for securely booting a computing device according to the techniques disclosed herein.

FIG. 5 is a flow diagram of a process for placing a device in a low power mode according to the techniques disclosed herein.

FIG. 6 is a block diagram of an example computing device that can be used to implement the computing device illustrated in FIG. 1.

FIGS. 7A, 7B, 7C, and 7D are schematic diagrams illustrating the contents of the secure executable image and the volatile memory of the computing device to illustrate another example implementation of the techniques disclosed herein.

FIGS. 8A, 8B, 8C, and 8D are schematic diagrams illustrating the contents of the secure executable image and the volatile memory of the computing device to illustrate another example implementation of the techniques disclosed herein.

Like reference symbols in the various drawings indicate like elements, in accordance with certain example implementations.

### DETAILED DESCRIPTION

Described herein are methods, systems, devices, computer readable media, and other implementations, for operating a computing device in one or more power modes. When performing a cold-boot, the computing device can be configured to execute a boot-loader that loads and authenticates a secure executable software (for example, an image) that contains software, data, configuration parameters, and other information for booting up and operating the computing device. The computing device can be configured to operate in one or more low power modes to conserve power. The computing device can be configured to power down various components of the computing device that are not necessary to the operation of the computing device while in a particular low power mode in order to conserve power. The computing device can be configured to maintain hardware, software, or a combination thereof configured to cause the computing device to exit from one power mode and to enter into another power mode responsive to predetermined conditions. For example, the computing device transitions from a first power mode to a second power mode where the first power mode is a lower power mode than the first power mode or vice versa. One of the power modes may be a full power mode of operations in which the power consumption of the computing device has not been reduced. The particular conditions that trigger the computing device to enter into the low power operating mode or exit from the low power operating mode can depend on the hardware, software, and the configuration of the particular device. Some devices may be configured to be capable of entering into more than one low power mode, where each low power reduces the power consumption and/or the functionality of the device to a different extent compared to a full power mode in which no steps to reduce power consumption by the computing device have been taken. One way that the computing device can be configured to reduce power consumption is by powering down at least a portion of the volatile memory of the computing device. Powering down the volatile memory of the computing device causes the information stored therein to be lost. If at least a portion of this information includes executable software required to operate the computing device in another power mode and the computing device exits the current power mode to this other power mode, then the lost information must be recovered from the secure executable image stored in non-volatile memory and re-authenticated before the device can be booted up in the other power mode. In conventional computing devices, the entire secure executable image would need to be reloaded and re-authenticated in this situation. This approach can add significant latency to the process of returning the device the normal operating mode from a low power operating mode. The techniques disclosed herein can improve the speed at which the computing device can return to full operational mode after entering into a low power operating mode by determining which information was lost due to components of the computing device being powered down in the low power operating mode and to selectively reload and re-authenticate only those components that need to be recovered. These techniques can significantly improve the performance of the computing device when exiting from a low power operating mode without compromising the security of the computing device.

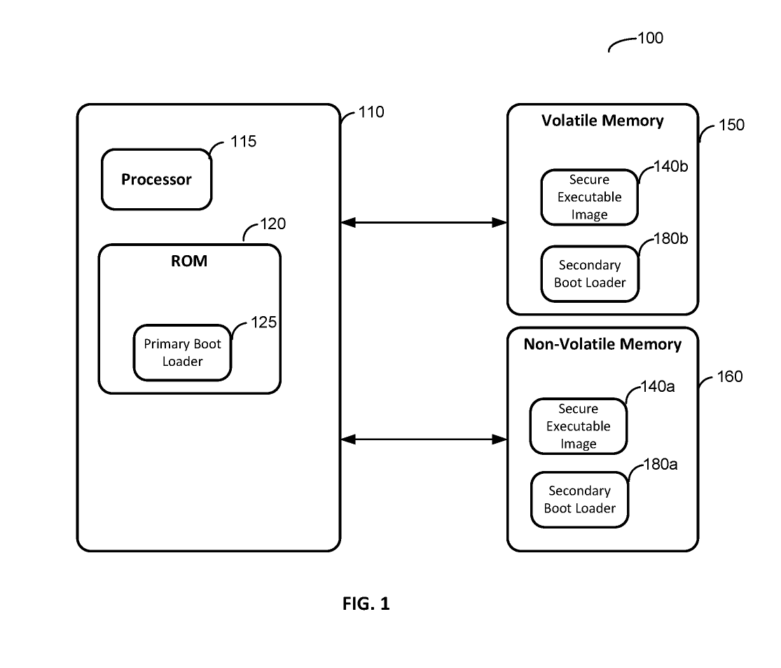

FIG. 1 is a schematic diagram of an example computing device 100 in which the techniques disclosed herein can be implemented, in accordance with certain example implementations. The computing device 100 can be a smart phone, a wearable computing device (such as a smartwatch), a tablet or other handheld computing device, an onboard computing device of a car or other vehicle, a laptop computer, an integrated circuit such as a system on chip (SoC) or other similar computing device. The computing device 100 can also be an Internet of Things (IoT) device, an enhanced Machine Type Communication (eMTC) device, or other such internetworked device. The techniques disclosed herein can also be used in other types of computing devices, such as set top boxes, digital video recorders, and/or other such computing devices that include a processor configured to execute program code stored in a persistent memory of the computing device. The computing device 100 is configured to operate in at least one low power mode and a full power mode. The computing device 100 is configured to power down at least some components or parts of components of the computing device 100 in order to conserve power when operating in a low power mode in order to conserve power and not to power down any components while operating in the low power mode. The particular low power modes that that computing device 100 is capable of being operate in can be dependent on the hardware configuration, configuration information included in the secure executable image executable by the computing device 100, or both. Additional information regarding the low power mode and the configuration thereof will be discussed further with respect to the example implementation illustrated in the subsequent figures. The techniques disclosed herein can also be used to configure the computing device 100, which is operating in a first low power mode, to operate in a second low power mode, where the computing device 100 is configured to consume less power while operating in the first low power mode than in the second low power mode.

The computing device comprises an integrated circuit 110 that includes a processor 115 and a read-only memory (ROM) 120. The integrated circuit 110 can be a system on a chip (SoC) or other similar device that integrates components of a computing device on an integrated circuit. The ROM 120 comprises non-volatile memory that can only be read once the data has been written to the memory and retains the data even if power to the ROM 120 is lost. The ROM 120 can comprise programmable read-only memory (PROM), field-programmable read-only memory (FPROM), one-time programmable non-volatile memory (OTP NVM), and/or other forms of digital memory in which each bit of data is represented by a fuse or antifuse. Other types of read-only memory can also be used.

The computing device 100 can also include a volatile memory 150 and a non-volatile memory 160. The volatile memory 150 and/or the non-volatile memory 160 may be included on the integrated circuit 110 or one or both of the volatile memory 150 and the non-volatile memory 160 may be external to the integrated circuit 110. Where the volatile memory 150 and/or the non-volatile memory 160 are located external to the integrated circuit 110, these components can be communicatively coupled to the processor 115 and/or other components of the integrated circuit 110 via a data bus. The volatile memory 150 can comprise memory that is configured to maintain the data stored therein while power is provided to the volatile memory 150. The contents of the volatile memory 150 will be lost if the power supply to the computing device 100 is lost. The volatile memory 150 can comprise synchronous dynamic random-access memory (SDRAM), double data rate synchronous dynamic random-access memory (DDR SDRAM), other types of volatile memory, or a combination thereof.

The volatile memory 150 can be configured such that portions of the volatile memory 150 can be powered down while retaining power to the remaining portions of the volatile memory 150, and thus, retaining the contents of the portions of the volatile memory that are not powered down. Portions of the volatile memory 150 and other components of the computing device 100 can be configured to be powered down when the computing device 100 enters into a low power mode in order to reduce power consumption by the computing device 100. The size of the portions of the volatile memory 150 that may be independently powered down can vary based on the particular hardware implementation of the volatile memory 150. Some implementations of the volatile memory 150 can be divided into memory banks which may be independently powered down or powered up. Each memory bank comprises a logical unit of storage that is dependent on the hardware implementing the volatile memory 150. The size of a memory bank may be determined by a memory controller associated with the integrated circuit 110 (not shown) and the organization of hardware components of the volatile memory 150. SDRAM and DDR SDRAM can be organized into memory banks that comprise multiple rows and columns of storage units that may be spread out over more than one integrated circuit. The size of a memory bank may be determined by number of bits in a column and a row of memory. The number of bits comprising a memory bank can depend on the memory bus width. Thus, the size of a memory bank may be equal to the number of bits that may be read in a read operation or the number of bits that may be written in a write operation.

The non-volatile memory (NVM) 160 comprises persistent memory that is configured to maintain the data stored therein even if power to the non-volatile memory 160 is lost. The non-volatile memory 160 can be configured to be written to multiple times. The NVM 160 can comprise flash memory, other types of non-volatile memory, or a combination thereof. The non-volatile memory 160 can be used to store a secure executable image 140a that includes executable program code, configuration data, and/or other information that can be used to boot the computing device 100. The secure executable image 140a can include executable program code, configuration data, and/or other information that can be used to operate the computing device 100 in one or more low power modes and a full power mode in which components or portions thereof of the computing device 100 have not been powered down in order to reduce power consumption by the computing device 100. The secure executable image 140a can also include executable program code, configuration data, and/or other information that can be used to place the computing device 100 in a low power mode and to return the computing device to the full power mode from a low power mode. Contents of the secure executable image 140a can be copied from the NVM 160 to the volatile memory 150 (represented by secure executable image 140b) during a cold boot process in which the computing device 100 is started up from a powered down state in which the operating system, startup applications, and various hardware components are powered up and configured to operate the computing device 100 in the full power mode. The secure executable image 140b and/or other software can be stored in the NVM 160 and copied to the volatile memory 150. One or more segments of such software may need to be restored to segments of the volatile memory 150 that were powered down when the computing device 100 entered into a low power state.

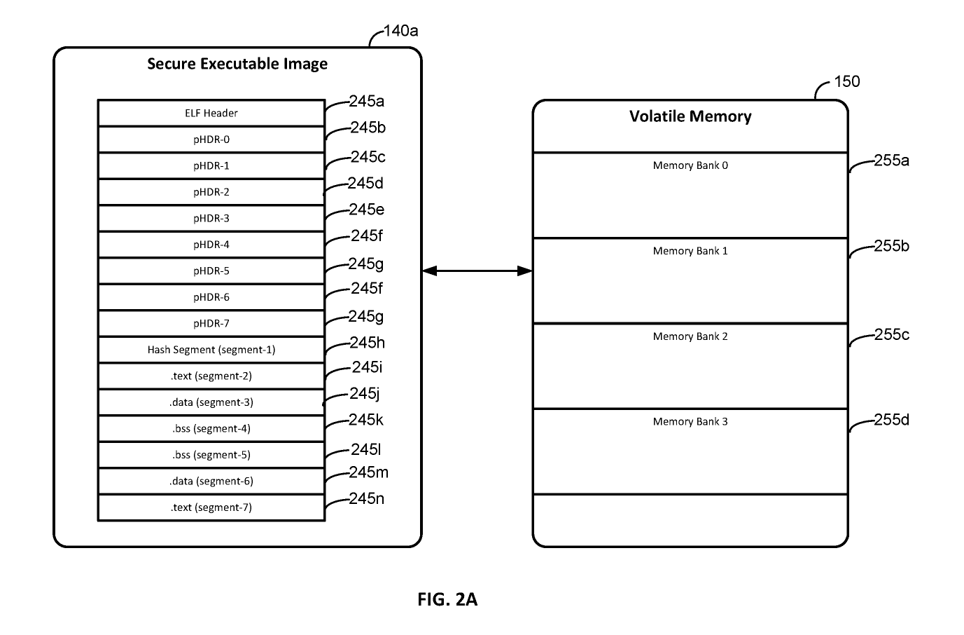

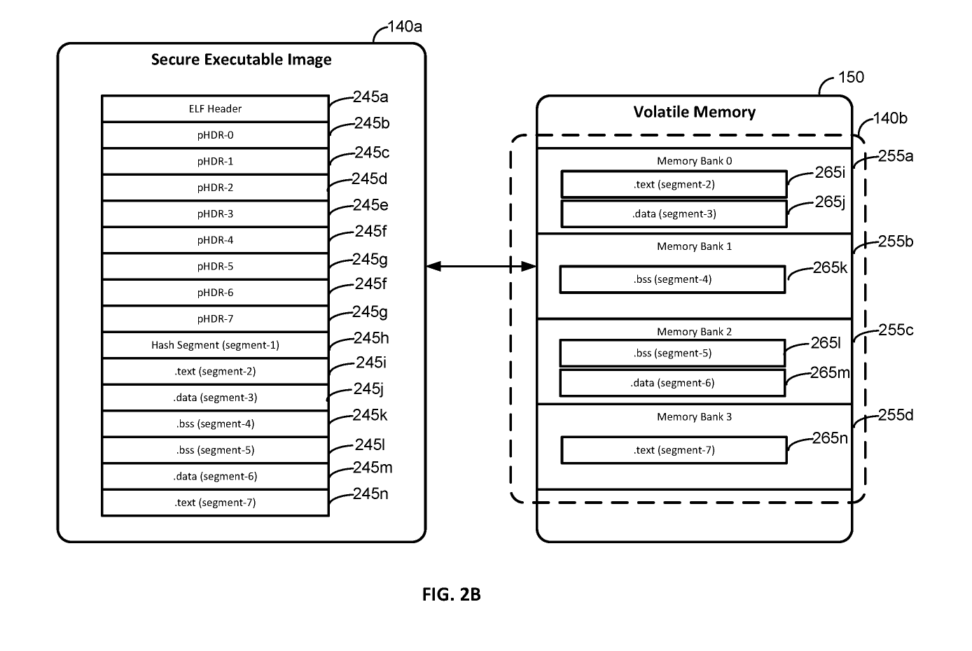

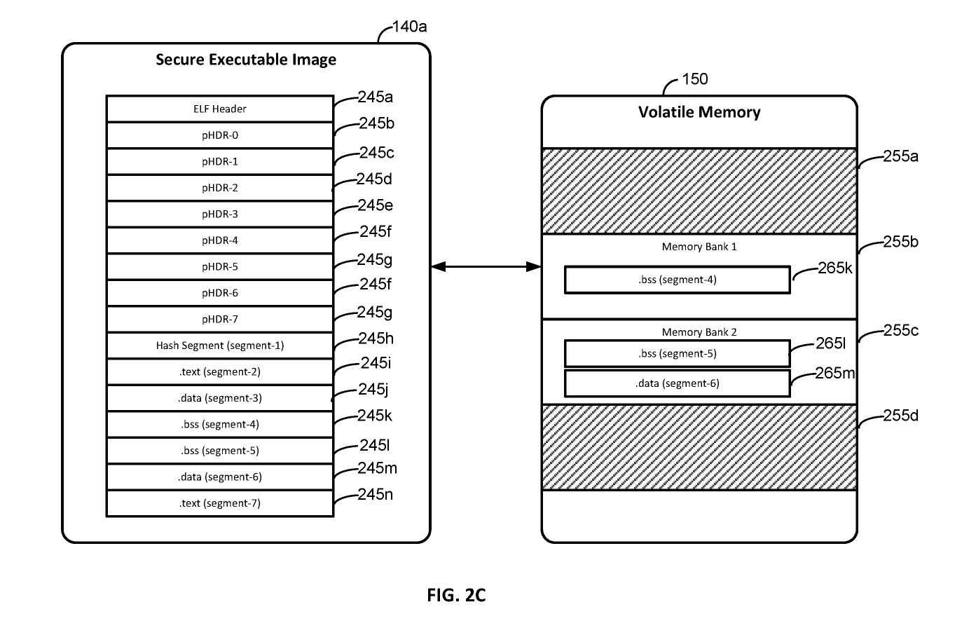

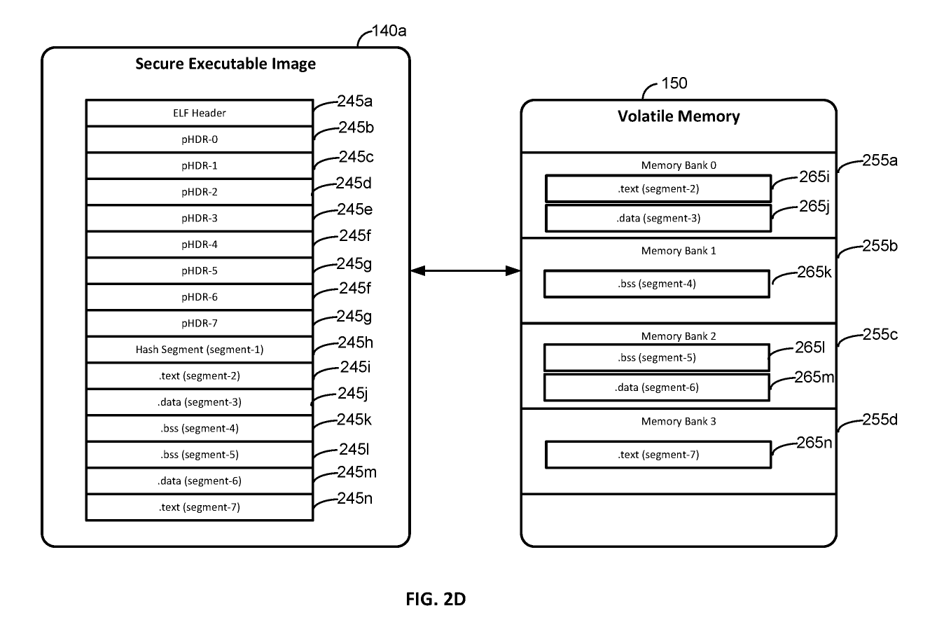

The ROM 120 can include a primary boot loader 125 that comprises executable program code and configuration data for starting the boot process. The primary boot loader 125 can be stored in a portion of the ROM 120 that the processor 115 is configured to access at the start of the boot process. The primary boot loader 125 can be configured to copy the secondary boot loader 180a from the NVM 160 to the volatile memory 150 and to begin executing the secondary boot loader 180b from the volatile memory 150, to authenticate the secondary boot loader, and to hash-verify the secondary boot loader. The secondary boot loader can be hash-verified by generating a hash value of the secondary boot loader executable content and comparing the hash value to a reference hash value to determine whether the secondary boot loader has been corrupted or altered. If this authentication and verification fails, then the primary boot loader 125 can be configured to abort the boot process. The specific authentication and validation performed by the primary boot loader 125 can vary from implementation to implementation. The secondary boot loader 180b can be configured to copy the contents of the secure executable image 140a from the NVM 160 to the volatile memory 150, to authenticate the contents, and to hash-verify the contents. If this authentication and verification fails, then the secondary boot loader 180b can be configured to abort the boot process. The secondary boot loader 180b can be configured to continue booting the computing device 100 into the full power mode utilizing the secure executable image 140b stored in the volatile memory 150. As discussed above, when the computing device 100 enters into a low power mode, one or more segments of the volatile memory 150 can be powered down to conserve power. The examples that follow in FIGS. 2A, 2B, 2C, 2D, 7A, 7B, 7C, and 7D, 8A, 8B, 8C, and 8D illustrate how the computing device 100 entering into a low power mode can impact the volatile memory and the contents thereof. The examples of FIGS. 2A, 2B, 2C, 2D, 7A, 7B, 7C, and 7D, 8A, 8B, 8C, and 8D also illustrate how the computing device 100 can be brought back from the low power mode to a full power mode, and the contents of the volatile memory that were lost due to the segments of memory in which they were stored being powered can be restored. The techniques illustrated herein can also be used to bring the computing device from a first power mode that is lower than a second power mode, in which the computing device 100 consumes less power while operating under the second power mode, but the second power mode is not the full operating mode of the computing device 100 in which no components of the computing device 100 have been powered down to conserve power.

FIGS. 2A, 2B, 2C, and 2D are schematic diagrams illustrating the contents of the secure executable image and the volatile memory of the computing device to illustrate an example implementation of the techniques disclosed herein. FIGS. 2A, 2B, 2C, and 2D illustrate more details of the secure executable image 140a and the configuration and contents of the volatile memory 150 illustrated in FIG. 1 as the computing device 100 is cold booted from a powered down state, enters a low power mode, and exits the low power mode and restores the contents of the volatile memory. Each of the FIGS. 2A, 2B, 2C, and 2D illustrates an example stage of these processes. The examples illustrated in FIGS. 2A, 2B, 2C, and 2D FIGS. 2A, 2B, 2C, and 2D are intended to illustrate the concepts disclosed herein. The contents and layout of the secure executable image 140a and the contents and layout of the volatile memory 150 are not limited to the specific examples illustrated in FIGS. 2A, 2B, 2C, and 2D, nor are the particular power modes that can be implemented limited to the low power mode and the full power mode discussed with respect to FIGS. 2A, 2B, 2C, and 2D.

FIG. 2A illustrates an initial state of the computing device 100 at the time that the computing device 100 is cold booted from a powered down state. The secure executable image 140a is located in the NVM 160. The volatile memory 150 was powered down and does not contain any data. As can be seen from FIG. 2A, the secure executable image 140a comprises a plurality of logical segments that contain data and/or executable program code for operating the computing device 100. The format of the secure executable image 140a is an Executable and Linkable Format (ELF) format, which is a flexible file format that can be used to store executable program code, object code, shared libraries, and/or configuration information for such executable content. While the examples illustrated in FIGS. 2A, 2B, 2C, and 2D utilize an ELF format for the secure executable image 140a, the techniques disclosed herein are not limited to such a format nor are implementations that do use an ELF format limited to the particular configuration discussed with respect to FIGS. 2A, 2B, 2C, and 2D. The secure executable image 140a can be formatted utilizing other file formats that can be used to deploy signed and authenticatable program code and/or program data on a computing device, such as the computing device 100. The secure executable image 140a includes a file header 245a that defines various parameters associated with the contents of the secure executable image 140a, such as how many bits the addresses utilized therein include, the target operating system for the contents, the instruction set architecture for which the contents are defined, the memory address of an entry point from which the software execution begins, and information regarding the size of the program entry table and the section entry tables. The program header table comprises entries 245b-245g in this example. The program header table comprises entries that tell the system how to create a process image can include the location of a segment in the file image, the virtual address of the segment in memory, and the size of the segment. The secure executable image 140a also includes a hash segment 245h. The hash segment 245h can include a header section that specifies the size of the hash segment, a hash table, and the size of the hash table in bytes or other suitable size indicator. The hash table can contain a hash of each segment in the secure executable image 140a and can include a hash of the file header 245a and hashes of the program headers of the program header table. The entry in the hash table corresponding to the hash segment 245h can be blank as the entire hash segment can be authenticated during the boot process. The hash table includes entries for each of the file segments 245i-245n in the order that these segments appear in the secure executable image 140a. The hash segment 245h can also include “signature+certificates” for hashes which can be used to authenticate hashes, which can in turn be used to hash-verify all segment(s) of the secure executable image 140a to ensure that none of the segments have been modified or corrupted. The hash values in the hash segment 245h provide a reference hash value that can be compared to a hash value of each segment. If the two hash values do not match, then that segment of the secure executable image 140a has been corrupted or modified. The secure executable image's segments 245i-245n include executable program code, data, and/or other information utilized by the executable program code.

The memory banks 255a-255d of the volatile memory do not contain any data at this stage. The contents of the volatile memory 150 would have been lost when the memory was powered down prior to the cold boot of the computing device 100. While the volatile memory 150 illustrated in FIGS. 2A, 2B, 2C, and 2D includes four memory banks, this implementation is intended to illustrate the techniques disclosed herein and implementations of these techniques are not limited to volatile memory 150 having four memory banks. The techniques disclosed herein can be used with any sort of logical segmentation of the volatile memory 150 in which each segment can be independently powered up or powered down.

FIG. 2B illustrates the state of the volatile memory 150 as the boot process from FIG. 2A continues. The processor 115 can execute the primary boot loader which copies the secondary boot loader 180a from the NVM 160 to the volatile memory 150, authenticates the secondary boot loader, and hash-verifies the secondary boot loader. Should the authentication and hash verification fail, then the primary boot loader can be configured to abort the boot process. The processor 115 can then execute the secondary boot loader 180b stored in the volatile memory 150. The secondary boot loader 180b can be configured to copy the segments of the secure executable image 140a stored in the NVM 160 to the volatile memory 150 and to authenticate and/or hash verify the segments. Should the authentication or verification fail, the secondary boot loader 180b can be configured to abort the boot process. The copy of the secure executable image 140b created in the volatile memory 150 may include a subset of the data stored in the secure executable image 140a. For example, the file header 245a, the program header table comprises entries 245b-245g, the hash segment 245h, and/or other segments of the secure executable image 140a may not be copied to the volatile memory 150. As can be seen in FIG. 2B, segments of the secure executable image 140a can be distributed across multiple memory banks of the volatile memory 150. The distribution of the segments across the memory banks of the volatile memory 150 can be determined based on the configuration of the volatile memory 150. The secure executable image 140a can contain information that indicates how the segments of the secure executable image 140a should be distributed across the memory banks of the volatile memory 150. One or more segments of the secure executable image may be copied to each memory bank. The distribution of these segments can be determined such that the segments comprising data and/or executable program code required to operate the computing device 100 in the low power mode and/or to facilitate exiting from the low power mode and returning the computing device 100 to the full power mode can be grouped into segments that are not powered down while the computing device 100 is operating in the low power mode.

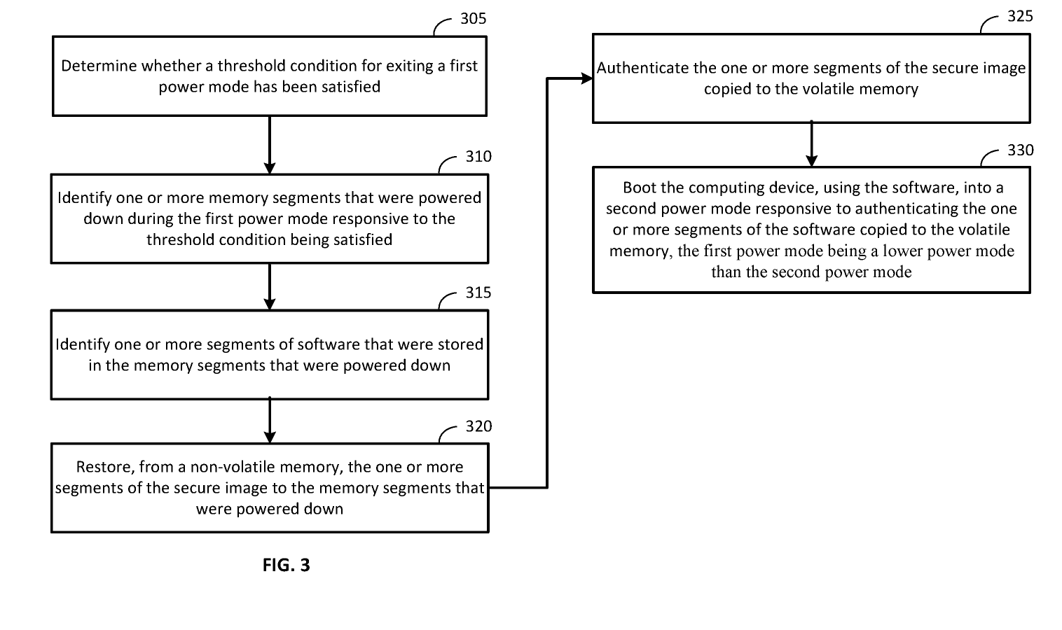

FIG. 2C illustrates the state of the volatile memory 150 as the computing device 100 enters into a low power mode following the full power mode illustrated FIG. 2B. The computing device 100 may be triggered to enter into the low power mode if the device has been idle for more than a predetermined period of time or based on other criteria as discussed below with respect to the process illustrated in FIG. 3. FIG. 2C illustrates that two of the memory banks, in this example memory bank 255a and memory bank 255d, were powered down and two of the memory banks, in this example memory bank 255b and memory bank 255c, are still powered up. The contents of the memory bank 255b and memory bank 255c have been retained and the contents of the memory bank 255a and memory bank 255d have been lost as those memory banks were powered down. The segments 265k, 2651, and 265m can comprise executable program code for operating the computing device 100 in the low power mode and for recovering from the low power mode to the full power mode. The particular memory banks that were selected to remain powered up and to be powered down in this example are meant to illustrate the concepts disclosed herein and are not intended to limit the techniques disclosed herein to this specific configuration.

FIG. 2D illustrates the state of the volatile memory 150 as the computing device 100 upon exiting from the low power mode following the low power mode illustrated FIG. 2C. The computing device 100 may be triggered to exit from the low power mode responsive to a signal or based on other one or more threshold criteria being satisfied as discussed below with respect to the process illustrated in FIG. 3. The processor 115 can execute a power mode recovery handler that determines which of the memory banks of the volatile memory 150 were powered down. The power mode recovery handler can also be configured to identify the segments of the secure executable image 140b that were stored in the memory banks that were powered down and to copy the corresponding segments from the secure executable image 140a stored in the NVM 160 to the respective memory bank of the volatile memory 150 in which the data was lost when the memory bank was powered down. The power mode recovery hander can be configured to authenticate and/or hash-verify the segments that were copied to the volatile memory 150 to ensure that the segments have not been corrupted or manipulated by an attacker or by malicious code that had been executed on the computing device 100. Some advantages of this approach is that the computing device 100 can recover from the low power mode much faster than would be possible in conventional approaches to recovery from such a low power mode, in which the entire secure executable image would need to be recopied to the volatile memory 150 from the NVM 160 and re-authenticated. FIGS. 2A, 2B, 2C, and 2D are schematic diagrams illustrating the contents of the secure executable image and the volatile memory of the computing device to illustrate an example implementation of the techniques disclosed herein. FIGS. 2A, 2B, 2C, and 2D illustrate more details of the secure executable image 140a and the configuration and contents of the volatile memory 150 illustrated in FIG. 1 as the computing device 100 is cold booted from a powered down state, enters a low power mode, and exits the low power mode and restores the contents of the volatile memory. Each of the FIGS. 2A, 2B, 2C, and 2D illustrates an example stage of these processes. The examples illustrated in FIGS. 2A, 2B, 2C, and 2D FIGS. 2A, 2B, 2C, and 2D are intended to illustrate the concepts disclosed herein. The contents and layout of the secure executable image 140a and the contents and layout of the volatile memory 150 are not limited to the specific examples illustrated in FIGS. 2A, 2B, 2C, and 2D, nor are the particular power modes that can be implemented limited to the low power mode and the full power mode discussed with respect to FIGS. 2A, 2B, 2C, and 2D.

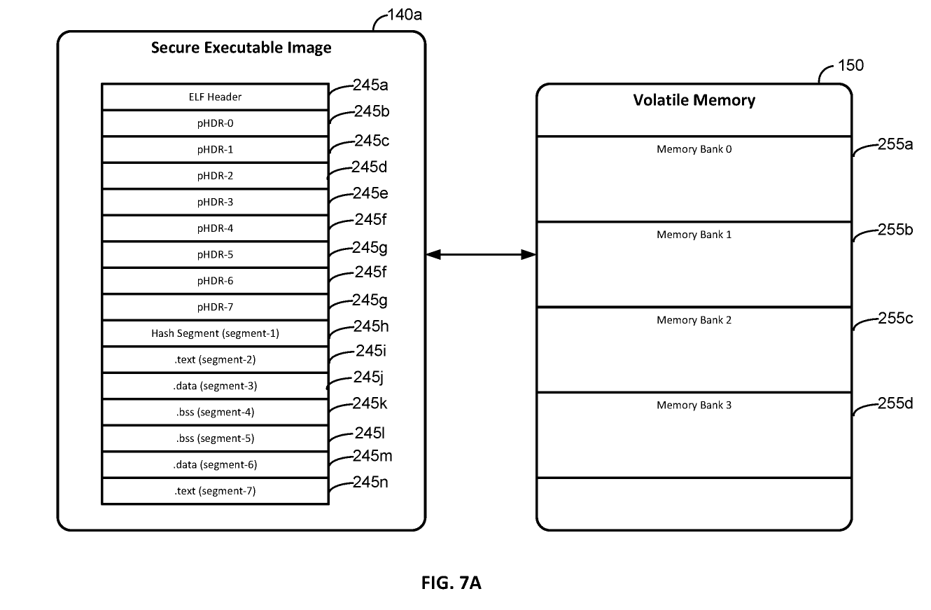

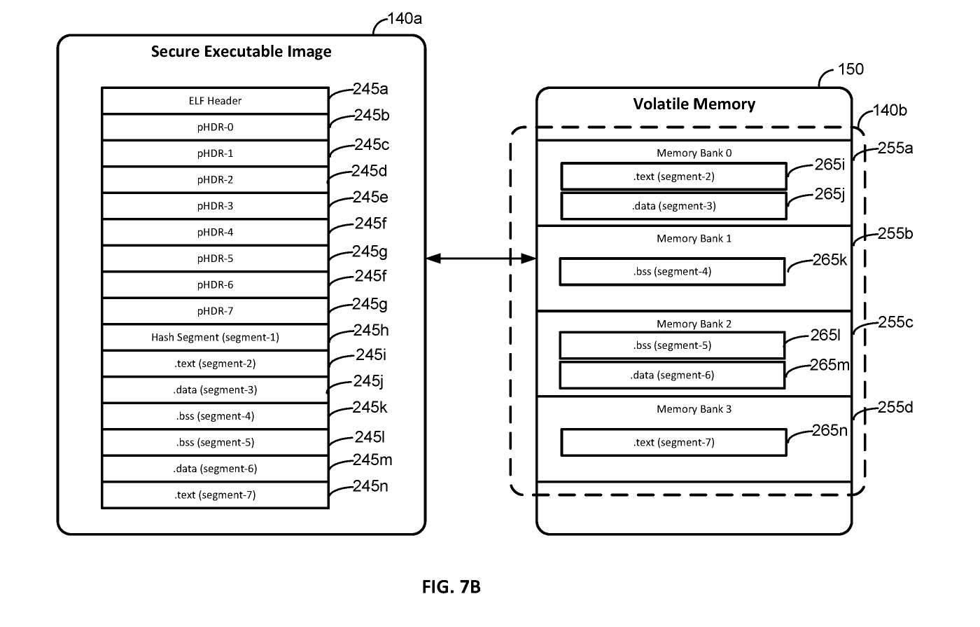

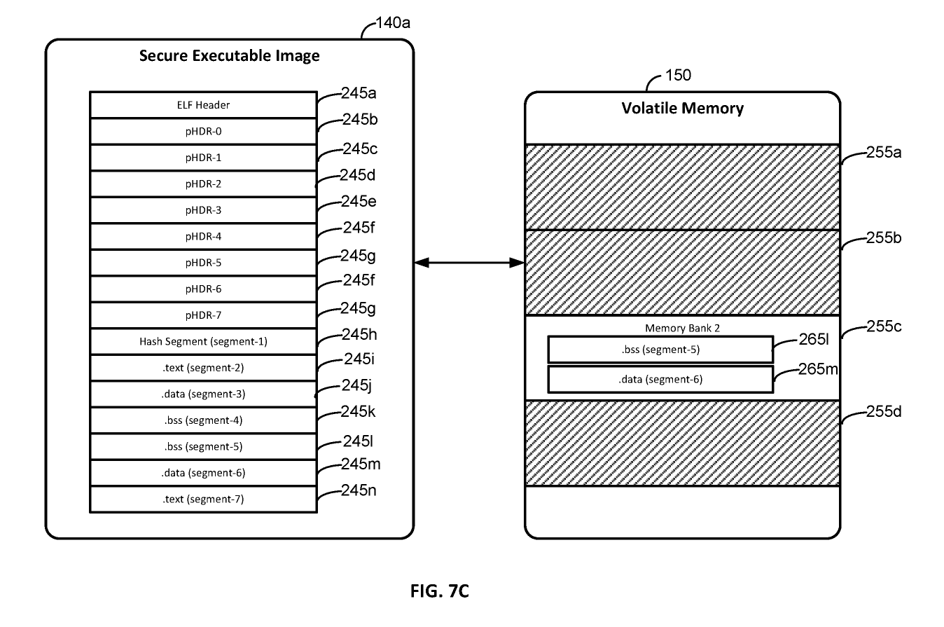

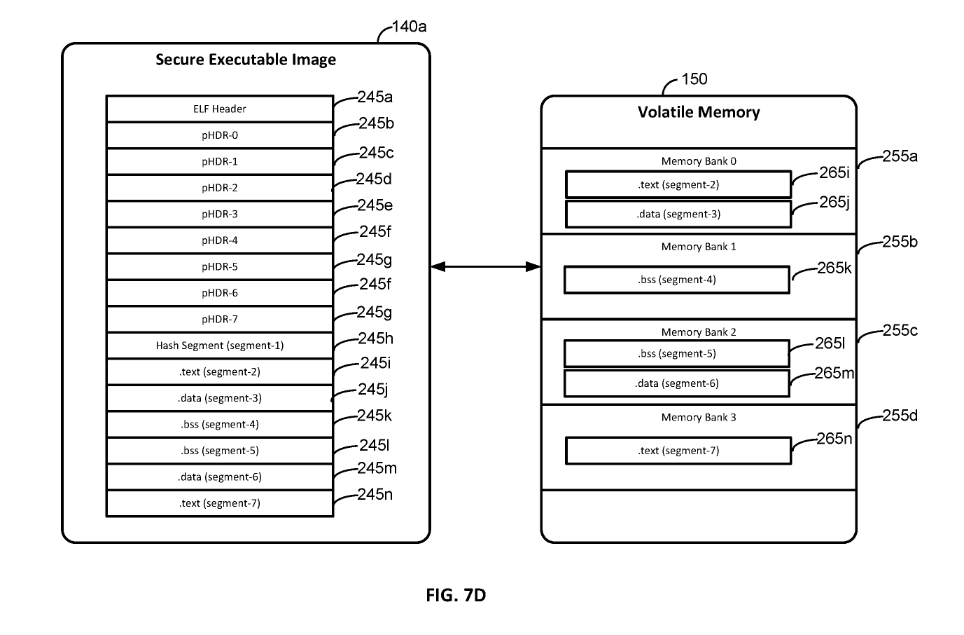

FIGS. 7A, 7B, 7C, and 7D are schematic diagrams illustrating the contents of the secure executable image and the volatile memory of the computing device to illustrate an example implementation of the techniques disclosed herein. FIGS. 7A, 7B, 7C, and 7D illustrate more details of the secure executable image 140a and the configuration and contents of the volatile memory 150 illustrated in FIG. 1 as the computing device 100 is cold booted from a powered down state, enters a low power mode, and exits the low power mode and restores the contents of the volatile memory. The low power mode illustrated in FIGS. 7A, 7B, 7C, and 7D is different from that illustrated in FIGS. 2A, 2B, 2C, and 2D. The low power mode illustrated in FIGS. 7A, 7B, 7C, and 7D is configured power down more memory banks of the volatile memory 150 in order to further reduce power consumption while the computing device 100 is operating the in low power mode illustrated in FIGS. 7A, 7B, 7C, and 7D versus that illustrated in FIGS. 2A, 2B, 2C, and 2D. Each of the FIGS. 7A, 7B, 7C, and 7D illustrates an example stage of these processes. The examples illustrated in 7A, 7B, 7C, and 7D are intended to illustrate the concepts disclosed herein. The contents and layout of the secure executable image 140a and the contents and layout of the volatile memory 150 are not limited to the specific examples illustrated in 7A, 7B, 7C, and 7D, nor are the particular power modes that can be implemented limited to the low power mode and the full power mode discussed with respect to 7A, 7B, 7C, and 7D.

FIG. 7A is similar to that of FIG. 2A in that FIG. 7A illustrates an initial state of the computing device 100 at the time that the computing device 100 is cold booted from a powered down state. The secure executable image 140a is located in the NVM 160. The volatile memory 150 was powered down and does not contain any data.

The memory banks 255a-255d of the volatile memory do not contain any data at this stage. The contents of the volatile memory 150 would have been lost when the memory was powered down prior to the cold boot of the computing device 100. While the volatile memory 150 illustrated in FIGS. 7A, 7B, 7C, and 7D includes four memory banks, this implementation is intended to illustrate the techniques disclosed herein and implementations of these techniques are not limited to volatile memory 150 having four memory banks. The techniques disclosed herein can be used with any sort of logical segmentation of the volatile memory 150 in which each segment can be independently powered up or powered down.

FIG. 7B illustrates the state of the volatile memory 150 as the boot process from FIG. 7A continues. FIG. 7B is similar to that of FIG. 2B in which the processor 115 can execute the primary boot loader which copies the secondary boot loader 180a from the NVM 160 to the volatile memory 150, authenticates the secondary boot loader, and hash-verifies the secondary boot loader. Should the authentication and hash verification fail, then the primary boot loader can be configured to abort the boot process. The processor 115 can then execute the secondary boot loader 180b stored in the volatile memory 150. The secondary boot loader 180b can be configured to copy the segments of the secure executable image 140a stored in the NVM 160 to the volatile memory 150 and to authenticate and/or hash verify the segments. Should the authentication or verification fail, the secondary boot loader 180b can be configured to abort the boot process. The copy of the secure executable image 140b created in the volatile memory 150 may include a subset of the data stored in the secure executable image 140a.

FIG. 7C illustrates the state of the volatile memory 150 as the computing device 100 enters into a low power mode following the full power mode illustrated FIG. 7B. The low power mode illustrated in FIG. 7C is configured to consume less power than the example illustrated in FIG. 2C by powering down more memory banks than the example illustrated in FIG. 2C. The computing device 100 may be triggered to enter into the low power mode if the device has been idle for more than a predetermined period of time or based on other criteria as discussed below with respect to the process illustrated in FIG. 3. FIG. 7C illustrates that three of the memory banks, in this example memory bank 255a, memory bank 255b, and memory bank 255d, were powered down and one of the memory banks, in this example memory bank 255c, remains powered up. The contents of the memory bank 255c have been retained and the contents of the memory bank 255a, memory bank 255b, and memory bank 255d have been lost as those memory banks were powered down. The segments 265l and 265m can comprise executable program code for operating the computing device 100 in the low power mode and for recovering from the low power mode to the full power mode. The particular memory banks that were selected to remain powered up and to be powered down in this example are meant to illustrate the concepts disclosed herein and are not intended to limit the techniques disclosed herein to this specific configuration.

FIG. 7D illustrates the state of the volatile memory 150 as the computing device 100 upon exiting from the low power mode following the low power mode illustrated FIG. 7C. This example is similar to that illustrated in FIG. 2D where the computing device 100 has exited from a low power mode. The computing device 100 may be triggered to exit from the low power mode responsive to a signal or based on other one or more threshold criteria being satisfied as discussed below with respect to the process illustrated in FIG. 3. As discussed above with respect to FIG. 2D, the processor 115 can execute a power mode recovery handler that determines which of the memory banks of the volatile memory 150 were powered down, to identify the segments of the secure executable image 140b that were stored in the memory banks that were powered down, and to copy the corresponding segments from the secure executable image 140a stored in the NVM 160 to the respective memory bank of the volatile memory 150 in which the data was lost when the memory bank was powered down. The power mode recovery hander can be configured to authenticate and/or hash-verify the segments that were copied to the volatile memory 150 to ensure that the segments have not been corrupted or manipulated by an attacker or by malicious code that had been executed on the computing device 100. This approach avoids the need to copy the full secure executable image 140a from the NVM 160 saving both time and power as the device returns to the full power mode from the low power mode.

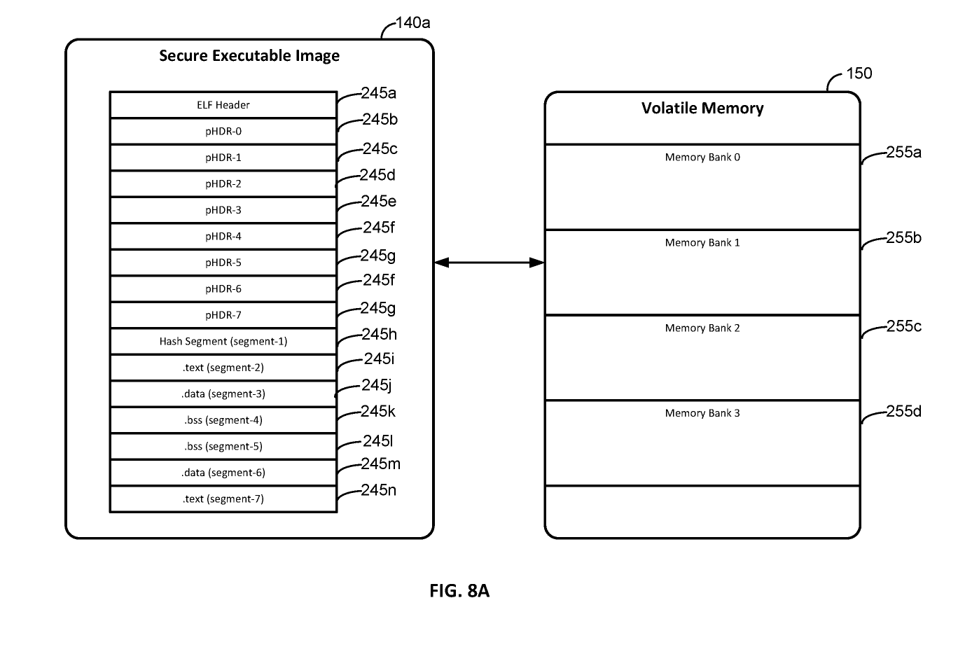

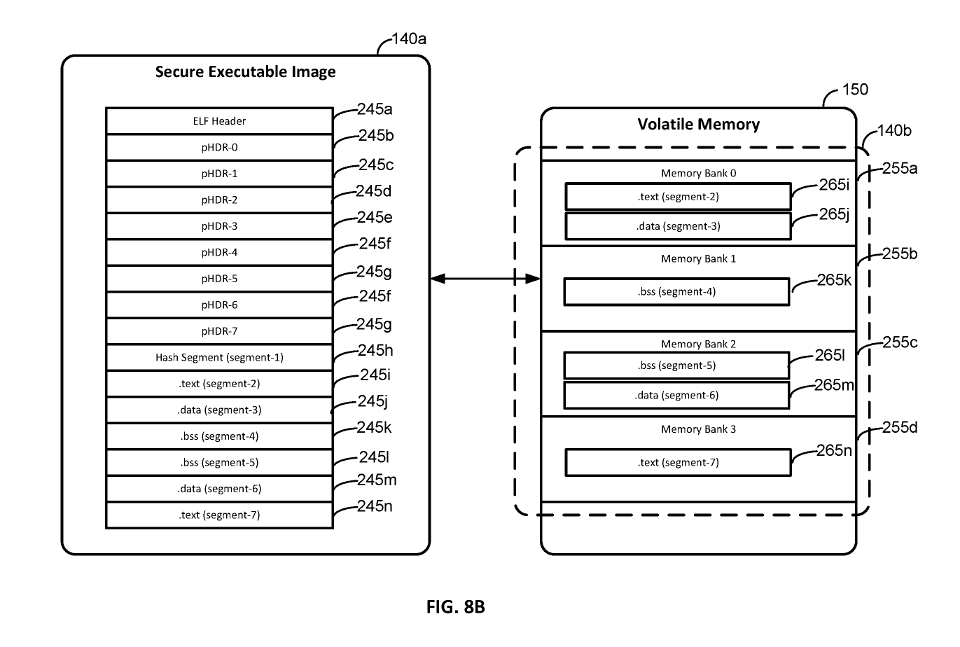

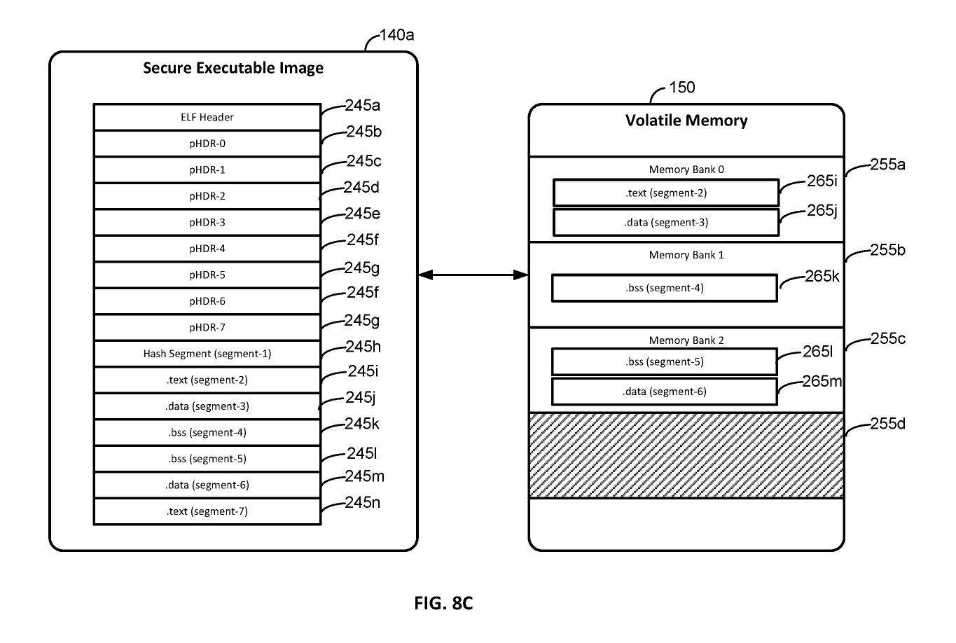

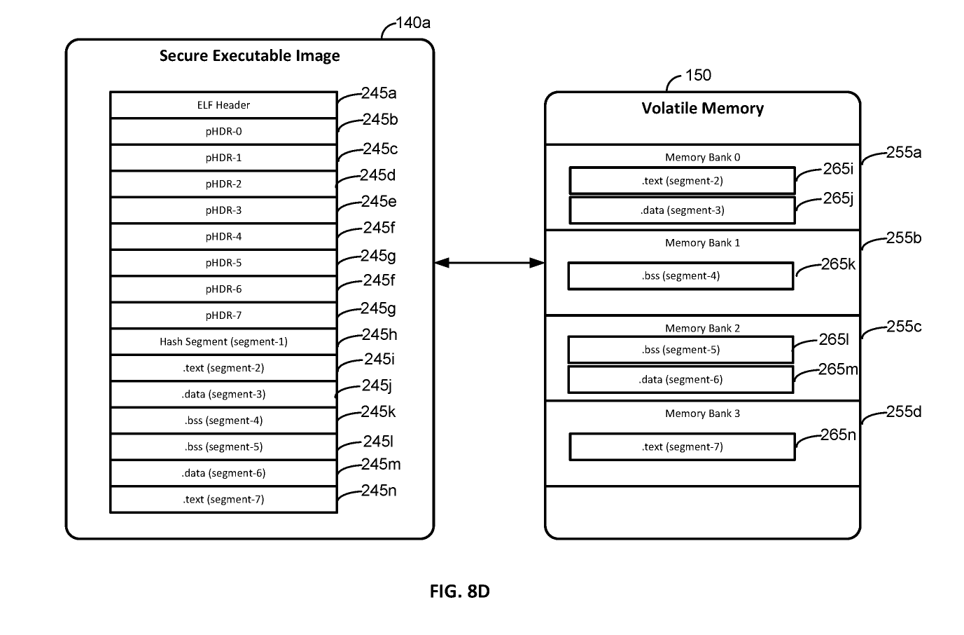

FIGS. 8A, 8B, 8C, and 8D are schematic diagrams illustrating the contents of the secure executable image and the volatile memory of the computing device to illustrate another example implementation of the techniques disclosed herein. FIGS. 8, 8B, 8C, and 8D illustrate more details of the secure executable image 140a and the configuration and contents of the volatile memory 150 illustrated in FIG. 1 as the computing device 100 is cold booted from a powered down state, enters a low power mode, and exits the low power mode and restores the contents of the volatile memory. The low power mode illustrated in FIGS. 7A, 7B, 7C, and 7D is different from that illustrated in FIGS. 2A, 2B, 2C, and 2D and 7A, 7B, 7C, and 7D. The low power mode illustrated in FIGS. 8A, 8B, 8C, and 8D is configured power down fewer memory banks of the volatile memory 150 than in the in low power mode examples illustrated in FIGS. 2A, 2B, 2C, and 2D and FIGS. 7A, 7B, 7C, and 7D.

FIG. 8A is similar to that of FIGS. 2A and 7A in that FIG. 8A illustrates an initial state of the computing device 100 at the time that the computing device 100 is cold booted from a powered down state. The secure executable image 140a is located in the NVM 160. The volatile memory 150 was powered down and does not contain any data.

FIG. 8B illustrates the state of the volatile memory 150 as the boot process from FIG. 8A continues. FIG. 8B is similar to that of FIGS. 2B and 7B in which the processor 115 can execute the primary boot loader which copies the secondary boot loader 180a from the NVM 160 to the volatile memory 150, authenticates the secondary boot loader, and hash-verifies the secondary boot loader.

FIG. 8C illustrates the state of the volatile memory 150 as the computing device 100 enters into a low power mode following the full power mode illustrated FIG. 8B. The low power mode illustrated in FIG. 8C is configured to consume more power than the examples illustrated in FIGS. 2C and 7C by powering fewer more memory banks than in the examples illustrated in FIGS. 2C and 7C. The computing device 100 may be triggered to enter into the low power mode if the device has been idle for more than a predetermined period of time or based on other criteria as discussed below with respect to the process illustrated in FIG. 3. FIG. 8C illustrates that one of the memory banks, in this example memory bank 255d, was powered down and three of the memory banks, in this example memory bank 255a, memory bank 255b, and memory bank 255c, remain powered up. The contents of the memory bank 255a, memory bank 255b, and memory bank 255c have been retained and the contents of the memory bank 255d have been lost as that memory bank was powered down. The segments 265i, 265j, 2651 and 265m can comprise executable program code for operating the computing device 100 in the low power mode and for recovering from the low power mode to the full power mode. The particular memory banks that were selected to remain powered up and to be powered down in this example are meant to illustrate the concepts disclosed herein and are not intended to limit the techniques disclosed herein to this specific configuration.

FIG. 8D illustrates the state of the volatile memory 150 as the computing device 100 upon exiting from the low power mode following the low power mode illustrated FIG. 8C. This example is similar to that illustrated in FIGS. 2D and 7D where the computing device 100 has exited from a low power mode. The computing device 100 may be triggered to exit from the low power mode responsive to a signal or based on other one or more threshold criteria being satisfied as discussed below with respect to the process illustrated in FIG. 3.

The computing device 100 can be configured to support each of the three example low power modes illustrated in FIGS. 2A, 2B, 2C, 2D, 7A, 7B, 7C, 7D, and 8A, 8B, 8C, and 8D and can be configured to enter into one of these low power modes based on one or more threshold conditions being satisfied. The computing device 100 can be configured to select a low power mode based on one or more threshold conditions, such but not limited to how long the computing device is expected to remain on battery power without a recharge from an external power source (where the device is battery powered), anticipated power consumption of the computing device based on anticipated power consumption by the processor 115, the volatile memory 150, the non-volatile memory 160, and/or other components of the computing device 100, sensor data indicating that the computing device 100 can enter into a low power state based on sensor data, and/or other threshold conditions being satisfied. For example, the computing device 100 may comprise a smartphone, smartwatch, fitness tracker, pet tracker, digital music player, portable gaming system or game controller or other device that is configured to enter into a low power mode based on user inactions or a lack thereof with the device. The computing device 100 can be configured to use sensor data, such as accelerometers, touch sensors, light sensors, to collect data and to make a determination whether to enter into a low power mode. The computing device 100 can be configured to enter a first low power mode in response to the computing device 100 not detecting any usage of the device for a first predetermined period of time and to enter a second low power mode responsive to the computing device not detecting any usage of the device for a second predetermined period of time, where the first predetermined period of time is shorter than the second predetermined period of time, and where the computing device 100 is configured to consume less power while operating in the second low power mode than while operating in the first low power mode. This example is intended to illustrate the concepts discussed herein.

FIG. 3 is a flow chart of a process for operating a computing device according to the techniques disclosed herein. The process illustrated in FIG. 3 can be used to securely boot a computing device from a low power mode according to the techniques disclosed herein. The process illustrated in FIG. 3 can be implemented by the processor 115 of the integrated circuit 110.

A determination whether a threshold condition for exiting a first power has been satisfied can be made (stage 305). The first power mode can be configured to exit the first power mode and to operate under a second power mode responsive to the threshold condition being satisfied. The first power mode is a lower power mode than the second power mode, meaning that the computing device 100 is configured to consume less power overall when operating in the first power mode than in the second power mode. The executable program code included in the secure executable image 140b in a memory bank of the volatile memory 150 that has not been powered down in response to the computing device 100 entering into the first power mode can include a power mode recovery handler. The processor 115 can be configured to periodically execute the power mode recovery handler to determine whether one or more conditions have been satisfied to exit the first power mode (or whichever power mode under which the computing device happens to be operating). For example, user activity on the computing device 100 may have been detected through inputs received via one or more user interfaces of the computing device 100, one or more sensors of the computing device 100 may have detected a condition which the computing device 100 should respond to by exiting the low power mode, the expiration of a timer which indicates that the computing device 100 should exit the first power mode. In some implementations, the computing device 100 can be configured to enter into one or more types of low power mode in which different components of the computing device or portions of these components are powered down in order to conserve power. Each of these low power modes may be associated with one or more threshold conditions that must be satisfied before the computing device 100 will be triggered to enter into and one or more threshold conditions that must be satisfied before the computing device 100 will be triggered to exit from that particular low power mode. The power mode recovery handler can be configured to proceed to stage 310 responsive to the one or more threshold conditions for exiting the first power mode being satisfied. Otherwise, the power mode recovery handler can return to stage 305 until being executed again by the processor 115 of the computing device 100. Alternatively, each power mode can be associated with one or more threshold conditions that must be satisfied before the computing device 100 will be triggered to enter into the power mode, and the computing device 100 can be configured to exit the low power mode responsive to the one or more entry conditions for another low power mode being satisfied.

One or more segments of the volatile memory that were powered down during the low power mode can be identified responsive to the one or more threshold conditions having been satisfied (stage 310). The power mode recovery handler can be configured to determine which of the memory banks of the volatile memory 150 were powered down in response to the computing device 100 entering into the first power mode. Information indicating which memory banks were powered down may be stored in a portion of the volatile memory 150 that was not powered down or in the NVM 160. A power mode type can be associated with each power mode, and the power mode type can be used to look up which components of the computing device 100 were powered down in response to operating the computing device in that power mode. The power mode recovery handler can be configured to access this information and to determine which memory banks were powered down. The secure executable image 140a can also include information can be used by the power mode recovery handler to determine which memory banks were powered down. Other components of the computing device 100 may have also been powered down while the computing device was operating in the first power mode. The power mode recovery handler can be configured to determine which other components of the computing device 100 were also powered down while the computing device was operating in the first power mode.

One or more segments of software that were stored in the one or more segments of the volatile memory that were powered down can be identified (stage 315). The software can comprise a secure executable image, such as the secure executable image 140b. The power mode recovery handler can also configured to identify the segments of the secure executable image 140b that were stored in the memory banks that were powered down and to copy the corresponding segments from the secure executable image 140a stored in the NVM 160 to the respective memory bank of the volatile memory 150 from which the data was lost when the memory bank was powered down.

One or more segments of the secure image can be restored, from the non-volatile memory, to the one or more segments of the volatile memory that were powered down (stage 320). The power mode recovery handler can be configured to copy the one or more segments of the secure executable image 140a to the volatile memory 150 to replace the segments of the secure executable image 140 that were lost when the memory banks of the volatile memory were powered down. The power mode recovery handler can be configured to access this information and to determine which segments of the secure executable image 140b were stored in the memory banks that were powered down. The secure executable image 140a can also include information can be used by the power mode recovery handler to determine which segments of the secure executable image 140b were stored in memory banks that were powered down.

The one or more segments of the secure image copied to the volatile memory can be authenticated and/or hash-verified (stage 325). The power mode recovery hander can be configured to authenticate the segments that were copied to the volatile memory 150 to ensure that the segments have not been corrupted or manipulated by an attacker or by malicious code that had been executed on the computing device 100. The power mode recovery handler can be configured to authenticate and/or hash-verify each of the one or more segments. The power mode recovery handler can be configured to hash-verify each of the one or more segment by computing a hash value of the segment that was copied to the volatile memory 150 and to compare the hash value to a hash value stored in the secure executable image 140a. The hash value can be stored in a hash segment of the secure executable image 140a, such as the hash segment 245h illustrated in the example of FIG. 2A. The power mode recovery handler can abort the boot process responsive to the authentication or verification failing. The hash segment 245h can also include “signature+certificates” for hashes which can be used to authenticate hashes, which can in turn be used to hash-check all segment(s) of the secure executable image 140a to ensure that none of the segments have been modified or corrupted.

The computing device can be booted using the secure image into the second power mode responsive to authenticating the one or more segments of the software restored to the volatile memory (stage 330). As discussed above, the first power mode is a lower power mode than the second power mode. Once the secure executable image 140b and/or other software has been recovered in the volatile memory 150 and the segments of the secure executable image 140b that were recovered have been authenticated, the processor 115 can be configured to execute a boot sequence using executable content from the secure executable image 140b to boot the computing device in the full power mode. An advantage of this approach is that the computing device 100 can recover from the low power mode much faster than would be possible in conventional approaches to recovery from such a low power mode, in which the entire secure executable image would need to be recopied to the volatile memory 150 from the NVM 160 and re-authenticated.

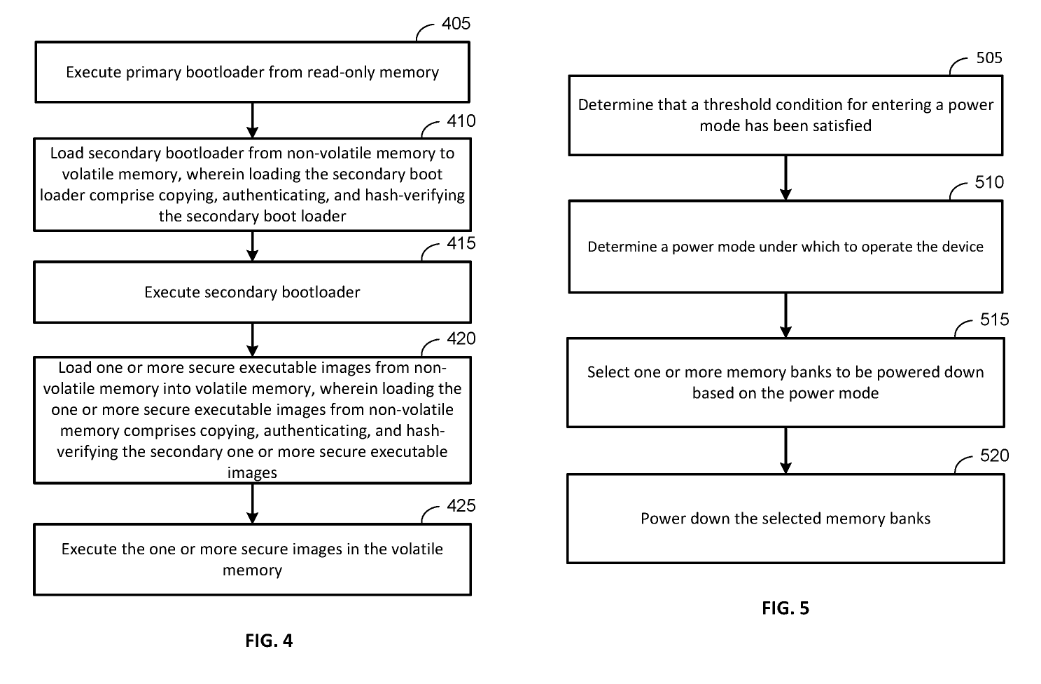

FIG. 4 is a flow diagram of a process for operating a computing device according to the techniques disclosed herein. The process illustrated in FIG. 4 can be used to securely boot a computing device in a cold boot process in which the computing device 100 is started up from a powered down state in which the operating system, startup applications, and/or various hardware components are powered up. The computing device 100 can be booted up into a power mode in which none of the components of the computing device are powered down in order to conserve power or can be booted up into a power mode in which one or more components of the computing device are powered down in order to conserve power. The process illustrated in FIG. 4 can be used in conjunction with the process illustrated in FIG. 3, and the process illustrated in FIG. 4 can precede the stages of the process illustrated in FIG. 4. The process illustrated in FIG. 4 can be implemented by the processor 115 of the integrated circuit 110.

A primary boot loader can be executed from a read-only memory (stage 405). A secondary boot loader can be loaded from non-volatile memory to volatile memory (stage 410). The processor 115 can be configured to execute the primary boot loader 125 located in the ROM 120 of the integrated circuit 110. The primary boot loader can be configured to perform initial setup functions including copying a secondary boot loader 180a from the NVM 160 to create a copy of the secondary boot loader 180b in the volatile memory. The secondary boot loader can be authenticated and hash-verified prior to executing the secondary boot loader. If the authentication or verification of the secondary boot loader fails, then the boot process can be aborted.

The secondary boot loader can be executed (stage 415). The primary boot loader 125 can be configured to cause the processor 115 to jump to the secondary boot loader 180b loaded into the volatile memory 150. The secondary boot loader 180b, when executed, can be configured to set up and execute core components of the operating system, applications, configure hardware components of the computing device 100, and to perform other functions to cause the computing device 100 to operate in at predetermined power operating mode.

One or more secure executable images can be loaded from the non-volatile memory 160 into the volatile memory 150 (stage 420). The secondary boot loader can be configured to copy, authenticate, and hash-verify each of the one or more secure executable images that are loaded into the volatile memory 150. Should the authentication or verification fail, the secondary boot loader can be configured to abort the boot process. Other software can be loaded in addition to the secure executable image(s) and the other software can be authenticated and hash-verified.

The one or more secure executable images can be executed to cause the computing device to boot up to the predetermined power mode (stage 425). The secondary boot loader 180b can be configured to access and execute one or more components off the secure executable image 140b as the secondary boot loader 180b is configuring the computing device 100 for operation. The power mode recovery handler and power mode entry handler can be loaded into the volatile memory 150 by the secondary boot loader 180b for handling of entry into and recovery from the power modes supported by the computing device 100.

FIG. 5 is a flow diagram of a process for placing a device in a power mode according to the techniques disclosed herein. The process illustrated in FIG. 5 can be used to place the computing device in a power mode that consumes less power than a power mode under which the computing device 100 is currently operating according to the techniques disclosed herein. The process illustrated in FIG. 5 can be implemented by the processor 115 of the integrated circuit 110.

A determination that a threshold condition for entering a power mode can be made (stage 505). The executable program code included in the secure executable image 140a and the secure executable image 140b can include a power mode entry handler. The power mode entry handler can be configured to monitor activity on the computing device 100 for certain events and to transition the computing device 100 from one power mode to another power mode in order to conserve power. The threshold condition can include determining that the computing device 100 has been in an idle state for a predetermined period of time, determining that the current time or date and time falls within a predetermined range during which the computing device 100 is expected to be in a low power mode, and/or other criteria.

A power mode under which the device can be operated can be determined (stage 510). The power mode can be a power mode that is a lower power mode than that under which the computing device 100 is currently operating. The power mode can be selected to conserve power by reducing the amount of power consumed by the computing device 100 overall. The power mode entry handler can be configured to determine the power mode based on the threshold criteria that were satisfied. Where the computing device 100 is capable of supporting more than one power mode, the power mode entry handler can be configured to enter a power mode associated with the threshold criteria that were satisfied. The power mode entry criteria for each of the power modes can be defined in the secure executable image 140a, or may be included in the ROM 120 or the NVM 160.

One or more memory banks to be powered down can be selected based on the power mode determined in stage 510 (stage 515). The power mode entry handler can be configured to select one or more memory banks based on the power mode determined in stage 510. The power mode entry handler can be configured to select memory banks to be powered down that do not include executable program code, configuration data, or other information needed to operate the power mode entry handler and the power mode recovery handler. The number of memory banks that are powered down can depend on the configuration of the hardware comprising the volatile memory 150, the capacity of an onboard power source (if one is present), the configuration of other components of the computing device 100, and the amount by which the power consumption of the computing device is desired to be reduced.

The selected memory banks can be powered down (stage 520). The power mode entry handler can be configured to power down the selected one or more memory banks of the volatile memory 150. Other components of the computing device 100 can also be powered down in response to the determination to enter the low power mode. The particular components to be powered down can be determined based on the low power mode that the device is entering into. The power mode recovery handler can be executed periodically to determine whether a threshold condition or conditions associated with the low power mode have been satisfied and can be configured to restore the operation of the computing device 100 in the second power mode as discussed with respect to FIG. 3, wherein the computing device 100 consumes less power when operating in the first power mode than when operating in the second power mode.

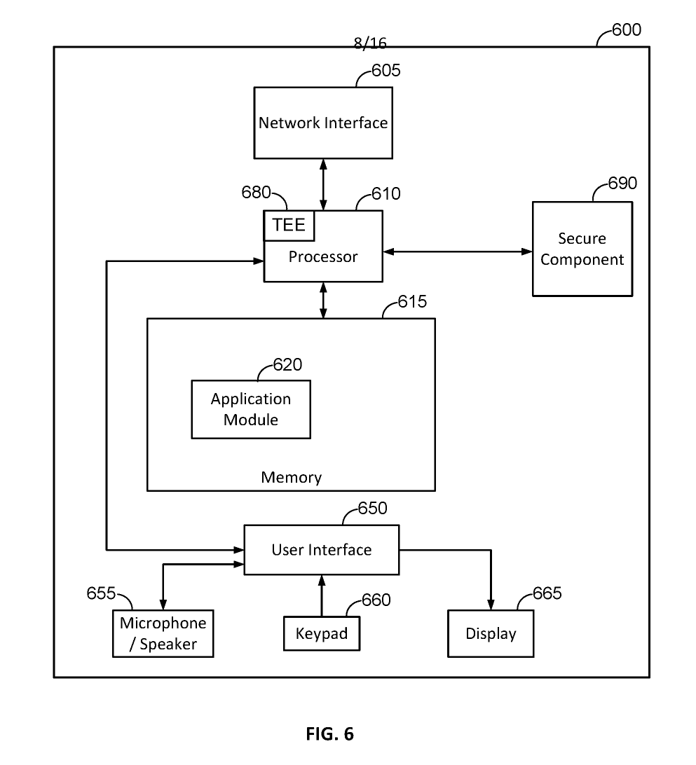

FIG. 6 is a block diagram of an example computing device 600 that can be used to implement the computing device 100 illustrated in FIG. 1. The computing device 600 can be used to implement, at least in part, the processes illustrated in FIGS. 2-5. FIG. 6 is a schematic diagram illustrating various components of an example computing device 600. For the sake of simplicity, the various features/components/functions illustrated in the schematic boxes of FIG. 6 are connected together using a common bus to represent that these various features/components/functions are operatively coupled together. Other connections, mechanisms, features, functions, or the like, can be provided and adapted as necessary to operatively couple and configure a portable wireless device. Furthermore, one or more of the features or functions illustrated in the example of FIG. 6 can be further subdivided, or two or more of the features or functions illustrated in FIG. 6 can be combined. Additionally, one or more of the features or functions illustrated in FIG. 6 can be excluded.

As shown, the computing device 600 can include a network interface 605 that can be configured to provide wired and/or wireless network connectivity to the computing device 600. The network interface can include one or more local area network transceivers that can be connected to one or more antennas. The one or more local area network transceivers comprise suitable devices, circuits, hardware, and/or software for communicating with and/or detecting signals to/from one or more of the WLAN access points, and/or directly with other wireless devices within a network. The network interface 605 can also include, in some implementations, one or more wide area network transceiver(s) that can be connected to the one or more antennas. The wide area network transceiver can comprise suitable devices, circuits, hardware, and/or software for communicating with and/or detecting signals from one or more of, for example, the WWAN access points and/or directly with other wireless devices within a network.

The processor(s) (also referred to as a controller) 610 can be connected to the network interface and/or other components of the computing device 600. The processor can include one or more microprocessors, microcontrollers, and/or digital signal processors that provide processing functions, as well as other calculation and control functionality. The processor 610 can be coupled to storage media (e.g., memory) 615 for storing data and software instructions for executing programmed functionality within the mobile device. The memory 615 can be on-board the processor 610 (e.g., within the same IC package), and/or the memory can be external memory to the processor and functionally coupled over a data bus.

A number of software modules and data tables can reside in memory 615 and can be utilized by the processor 610 in order to manage both communications with remote devices/nodes, and/or perform the various security processes disclosed herein. As illustrated in FIG. 6, in some embodiments, the memory 615 can include an application module 620 which can implement one or more applications. It is to be noted that the functionality of the modules and/or data structures can be combined, separated, and/or be structured in different ways depending upon the implementation of the computing device 600.

The application module 620 can be a process running on the processor 610 of the computing device 600, which can request information from the application module 620 or other data from one of the other modules of the computing device 600. Applications typically run within an upper layer of the software architectures and can be implemented in a rich execution environment of the computing device 600. The application module 620 can be configured to perform one or more of the processes disclosed herein.

The processor 610 can include a trusted execution environment 680 and/or the computing device 600 may include a secure component 690. The trusted execution environment 680 and/or the secure component 690 can be used to implement at least a portion of the processes disclosed herein. The trusted execution environment 680 and/or the secure component 690 can be used to provide a secure computing environment for implementing the processes disclosed herein that can prevent the unauthorized party from tampering with and/or potentially disabling the processes disclosed herein.

The trusted execution environment 680 can be implemented as a secure area of the processor 610 that can be used to process and store sensitive data. The trusted execution environment 680 can be configured to execute trusted applications that provide end-to-end security for sensitive data by enforcing confidentiality, integrity, and protection of the sensitive data stored therein. The trusted execution environment 680 can be used to store encryption keys, secure application program code, and/or other sensitive information.

The computing device 600 can include a secure component 690 (also referred to herein as a trusted component). The computing device can include the secure component 690 in addition to or instead of the trusted execution environment 680. The secure component 690 can comprise autonomous and tamper-resistant hardware that can be used to execute secure applications and/or processes. The secure component 690 can be used to implement the processes for mitigating attacks on the baseband process disclosed herein and may implement these processes in combination with the trusted execution environment 680. The secure component 690 can be configured to store sensitive data and to provide confidentiality, integrity, and protection to the data stored therein. The secure component 690 can be used to store encryption keys, user data, and/or other sensitive data. The secure component 690 can be integrated with the hardware of the computing device in a permanent or semi-permanent fashion can be used to securely store data and/or provide a secure execution environment for applications.

The computing device 600 can further include a user interface 650 providing suitable interface systems, such as a microphone/speaker 655, a keypad 660, and a display 665 that allows user interaction with the computing device 600. The microphone/speaker 655. The keypad 660 can comprise suitable buttons for user input. The display 665 can include a suitable display, such as, for example, a backlit LCD display, and can further include a touch screen display for additional user input modes.

Computer programs (also known as programs, software, software applications or code) include machine instructions for a programmable processor, and may be implemented in a high-level procedural and/or object-oriented programming language, and/or in assembly/machine language. As used herein, the terms “processor-readable medium” and “machine-readable medium” refer to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

Memory may be implemented within the computing-based device or external to the device. As used herein the term “memory” refers to any type of long term, short term, volatile, nonvolatile, or other memory and is not to be limited to any particular type of memory or number of memories, or type of media upon which memory is stored.

If implemented in-part by hardware or firmware along with software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

As used herein, a mobile device or station (MS) refers to a device such as a cellular or other wireless communication device, a smartphone, tablet, personal communication system (PCS) device, personal navigation device (PND), Personal Information Manager (PIM), Personal Digital Assistant (PDA), laptop or other suitable mobile device which is capable of receiving wireless communication and/or navigation signals, such as navigation positioning signals. The term “mobile station” (or “mobile device” or “wireless device”) is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, tablet devices, etc., which are capable of communication with a server, such as via the Internet, WiFi, or other network, and to communicate with one or more types of nodes, regardless of whether satellite signal reception, assistance data reception, and/or position-related processing occurs at the device, at a server, or at another device or node associated with the network. Any operable combination of the above are also considered a “mobile station.” A mobile device may also be referred to as a mobile terminal, a terminal, a user equipment (UE), a device, a Secure User Plane Location Enabled Terminal (SET), a target device, a target, or by some other name.

While some of the techniques, processes, and/or implementations presented herein may comply with all or part of one or more standards, such techniques, processes, and/or implementations may not, in some embodiments, comply with part or all of such one or more standards.

What is claimed:

1. A method for operating a computing device comprising:
determining whether a threshold condition for exiting a first power mode has been satisfied;
identifying one or more segments of a volatile memory that were powered down while the computing device was operating in the first power mode responsive to the threshold condition being satisfied;
identifying one or more segments of software that were stored in the one or more segments of the volatile memory that were powered down;
restoring, from a non-volatile memory, the one or more segments of the software to the one or more segments of the volatile memory that were powered down; and
authenticating the one or more segments of the software.

2. The method of claim 1, further comprising:
booting the computing device using the software in a second power mode responsive to authenticating the one or more segments of the software restored to the volatile memory, the first power mode being a lower power mode than the second power mode.

3. The method of claim 1, further comprising:
powering up the one or more segments of the volatile memory that were powered down while the computing device was operating in the first power mode responsive to the threshold condition being satisfied.

4. The method of claim 1, wherein identifying the one or more segments of the volatile memory that were powered down while the computing device was operating in the first power mode further comprises:
determining the one or more segments of the volatile memory based on a power mode type associated with the first power mode.

5. The method of claim 4, wherein determining the one or more segments of the volatile memory further comprises determining the one or more segments of the volatile memory based on a hardware configuration of the computing device.

6. The method of claim 1, further comprising:
executing a power mode recovery handler stored in one or more other memory segments that were not powered down while operating the computing device in the first power mode.

7. The method of claim 1, further comprising:
determining the first power mode under which to operate the computing device;
selecting one or more memory banks to be powered down based on the first power mode; and
powering down the selected memory banks.

8. A computing device comprising:
means for determining whether a threshold condition for exiting a first power mode has been satisfied;
means for identifying one or more segments of a volatile memory that were powered down while the computing device was operating in the first power mode responsive to the threshold condition being satisfied;
means for identifying one or more segments of software that were stored in the one or more segments of the volatile memory that were powered down;
means for restoring, from a non-volatile memory, the one or more segments of the software to the one or more segments of the volatile memory that were powered down; and
means for authenticating the one or more segments of the software.

9. The computing device of claim 8, further comprising:
means for booting the computing device using the software in a second power mode responsive to authenticating the one or more segments of the software restored to the volatile memory, the first power mode being a lower power mode than the second power mode.

10. The computing device of claim 8, further comprising:
means for powering up the one or more segments of the volatile memory that were powered down during the first power mode responsive to the threshold condition being satisfied.

11. The computing device of claim 8, wherein the means for identifying one or more segments of the volatile memory that were powered down while the computing device was operating in the first power mode further comprises:
means for determining the one or more segments of the volatile memory based on a power mode type associated with the first power mode.

12. The computing device of claim 11, wherein the means for determining the one or more segments of the volatile memory further comprises means for determining the one or more segments of the volatile memory based on a hardware configuration of the computing device.

13. The computing device of claim 8, further comprising:
means for executing a power mode recovery handler stored in one or more segments of the volatile memory that were not powered down while the computing device was operating in the first power mode.

14. The computing device of claim 8, further comprising:
means for determining the first power mode under which to operate the computing device;
means for selecting one or more memory banks to be powered down based on the first power mode; and
means for powering down the selected memory banks.

15. A computing device comprising:
a volatile memory;
a non-volatile memory;
software for booting the computing device stored in the non-volatile memory; and
a processor communicatively coupled to the volatile memory and the non-volatile memory and configured to:
determine whether a threshold condition for exiting a first power mode has been satisfied;
identify one or more segments of the volatile memory of the volatile memory that were powered down during the first power mode responsive to the threshold condition being satisfied;
identify one or more segments of the software that were stored in the one or more segments of the volatile memory that were powered down;
restore, from the non-volatile memory, the one or more segments of the software to the one or more segments of the volatile memory that were powered down; and
authenticate the one or more segments of the software restored to the non-volatile memory.

16. The computing device of claim 15, wherein the processor is further configured to:
boot the computing device, using the software, into a second power mode responsive to authenticating the one or more segments of the software copied to the volatile memory.

17. The computing device of claim 15, wherein the processor is further configured to:
power up the one or more segments of the volatile memory that were powered down while the computing device was operating in the first power mode responsive to the threshold condition being satisfied.

18. The computing device of claim 15, wherein the processor being configured to identify one or more segments of the volatile memory that were powered down while the computing device was operating in the first power mode is further configured to:
determine the one or more segments of the volatile memory based on a power mode type associated with the first power mode.

19. The computing device of claim 18, wherein the processor is configured to determine the one or more segments of the volatile memory based at least in part on a hardware configuration of the computing device.

20. The computing device of claim 15, wherein the processor is further configured to:
execute a power mode recovery handler stored in one or more segments of the volatile memory that were not powered down while the computing device was operating in the first power mode.

21. The computing device of claim 15, wherein the processor is further configured to:
determine the first power mode under which to operate the computing device;
select one or more memory banks to be powered down based on the first power mode; and
power down the selected memory banks.

22. A non-transitory, computer-readable medium, having stored thereon computer-readable instructions for operating a computing device, comprising instructions configured to cause the computing device to:
determine whether a threshold condition for exiting a first power mode has been satisfied;
identify one or more segments of a volatile memory that were powered down while the computing device was operating in the first power mode responsive to the threshold condition being satisfied;
identify one or more segments of software that were stored in the one or more segments of the volatile memory that were powered down;
restore, from a non-volatile memory, the one or more segments of the software to the one or more segments of the volatile memory that were powered down; and
authenticate the one or more segments of the software.

23. The non-transitory, computer-readable medium of claim 22, further comprising instructions configured to cause the computing device to:
boot the computing device, using the software, into a second power mode responsive to authenticating the one or more segments of the software restored to the volatile memory.

24. The non-transitory, computer-readable medium of claim 22, further comprising instructions configured to cause the computing device to:
power up the one or more segments of the volatile memory that were powered down while the computing device was operating in the first power mode responsive to determining that the threshold condition has been satisfied.

25. The non-transitory, computer-readable medium of claim 22, wherein the instructions configured to cause the computing device to identify one or more segments of the volatile memory that were powered down while the computing device was operating in the first power mode further comprise instructions configured to cause the computing device to:
determine the one or more segments of the volatile memory based on a power mode type associated with the first power mode.

26. The non-transitory, computer-readable medium of claim 25, wherein the instructions configured to cause the computing device to determine the one or more segments of the volatile memory further comprise instructions configured to cause the computing device to determine the one or more segments of the volatile memory based on a hardware configuration of the computing device.

27. The non-transitory, computer-readable medium of claim 22, further comprising instructions configured to cause the computing device to:
execute a power mode recovery handler stored in one or more segments of the volatile memory that were not powered down while the computing device was operating in the first power mode.

28. The non-transitory, computer-readable medium of claim 22, further comprising instructions configured to cause the computing device to:
determine the first power mode under which to operate the computing device;
select one or more memory banks to be powered down based on the first power mode; and
power down the selected memory banks.
